(19) United States
(12) Patent Application Publication
(10) Pub. No.: US 2026/0205880 A1
(43) Pub. Date: Jul. 16, 2026

(54) COMMUNICATION DEVICE AND COMMUNICATION METHOD THEREOF

(71) Applicant: MEDIATEK INC., Hsinchu City (TW)

(72) Inventors: Chien-Chih CHEN, Hsinchu City (TW); Shun-Yong HUANG, Hsinchu City (TW)

(21) Appl. No.: 19/018,002

(22) Filed: Jan. 13, 2025

(51) Int. Cl. H04W 28/08

(52) U.S. Cl. CPC H04W 28/0858

(57) ABSTRACT

A multi-link single radio (MLSR) device, comprises a processor and a single radio module. The processor is configured for selecting an optimal link from a plurality of radio links between the MLSR device and an AP device based on a plurality of link scores of the radio links. The single radio module is configured for communicating with the AP device through the selected optimal link. Each of the radio links is associated with a respective channel and a corresponding link score, and the corresponding link score is determined based on a channel bandwidth corresponding to the respective channel and a channel load value received from the AP device.

### TECHNICAL FIELD

The disclosure relates to a communication mechanism, and particularly relates to communication devices for performing multi-link operations (MLO) and a communication method thereof.

### BACKGROUND

With progressed technology for wireless communication, radio resources utilization has been significantly improved. For example, in a Wi-Fi_7 system, multi-link operations (MLO) are employed to enhance utilization of radio links. That is, in the communication system with MLO, a mobile station may communicate with an AP device through multiple radio links. In some scenarios, the mobile station functions as a multi-link single radio (MLSR) device, and the AP device may serve as a multi-link multi-radio (MLMR) device.

To better utilize radio resources, the MLSR device may select an optimal link from the multiple radio links between the MLSR device and the AP device. In the communication with the AP device through the selected optimal link, the MLSR device may acquire a better communication quality and a shorter latency in packet transmission, as superior to a single-link single radio (SLSR) device.

In order to more efficiently perform optimal link selection, there is a need to provide an improved link selection mechanism.

### SUMMARY

According to one embodiment of the present disclosure, a multi-link single radio (MLSR) device is provided. The MLSR device comprises a processor and a single radio module. The processor is configured for selecting an optimal link from a plurality of radio links between the MLSR device and an AP device based on a plurality of link scores of the radio links. The single radio module is configured for communicating with the AP device through the selected optimal link. Each of the radio links is associated with a respective channel and a corresponding link score, and the corresponding link score is determined based on a channel bandwidth corresponding to the respective channel and a channel load value received from the AP device.

According to another embodiment of the present disclosure, a communication method, performed by a multi-link single radio (MLSR) device, is provided. The communication method comprises the following steps. Selecting an optimal link from a plurality of radio links between the MLSR device and an AP device based on a plurality of link scores of the radio links. Utilizing the MLSR device to communicate with the AP device through the selected optimal link, by a single radio module of the MLSR device. Wherein each of the radio links is associated with a respective channel and a corresponding link score, and the corresponding link score is determined based on a channel bandwidth corresponding to the respective channel and a channel load value received from the AP device.

### BRIEF DESCRIPTION OF THE DRAWINGS

FIG. 1A is a block diagram of a communication system 1000 according to an embodiment of the present disclosure.

FIG. 1B is a block diagram of the STA device 201 of the communication system 1000 in FIG. 1A.

FIG. 2A is a schematic diagram illustrating a format of action fields in the radio measurement request frame.

FIG. 2B is a schematic diagram illustrating a format of the measurement request element of FIG. 2A.

FIG. 2C is a schematic diagram illustrating a format of the measurement request field for the channel load request.

FIG. 3A is a schematic diagram illustrating a format of action fields in the radio measurement report frame.

FIG. 3B is a schematic diagram illustrating a format of the measurement report element of FIG. 3A.

FIG. 3C is a schematic diagram illustrating a format of the measurement report field of FIG. 3B.

FIG. 4 is a schematic diagram illustrating the STA device 201 determines an optimal link for subsequent communication with the AP device 100 during the process of establishing a connection, according to an embodiment of the present disclosure.

FIG. 5 is a schematic diagram illustrating the STA device 201 requests channel load reports for the radio links LK1 and LK2 from the AP device 100, according to another embodiment of the present disclosure.

FIG. 6A is a schematic diagram illustrating the STA device 201 decides an optimal link of the radio links LK1 and LK2, according to an embodiment of the present disclosure.

FIG. 6B is a schematic diagram illustrating the STA device 201 decides an optimal link of the radio links LK1 and LK2, according to another embodiment of the present disclosure.

FIG. 7 is a schematic diagram illustrating the STA device 201 decides an optimal link of the radio links LK1 and LK2, according to still another embodiment of the present disclosure.

FIG. 8 is a schematic diagram illustrating the STA device 201 decides the optimal link in a comparative example.

FIG. 9 is a flow diagram illustrating a communication method according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

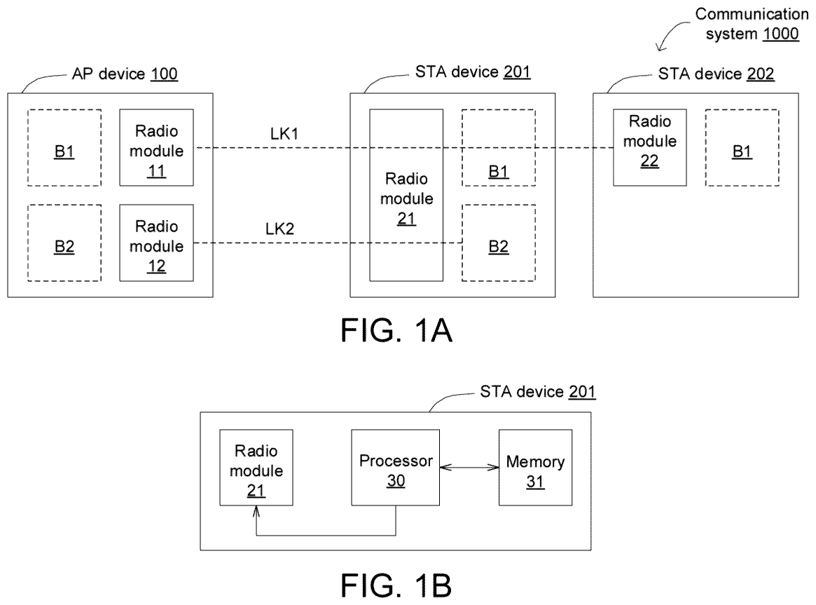

FIG. 1A is a block diagram of a communication system 1000 according to an embodiment of the present disclosure. The communication system 1000 may perform multi-link operations (MLO) through a plurality of radio links. Referring to FIG. 1A, the communication system 1000 includes an AP (i.e., access-point) device 100 and at least one STA (i.e., station) device, such as STA device 201. In the example of FIG. 1A, the communication system 1000 includes two STA devices 201 and 202, which are communicatively coupled to the AP device 100.

The AP device 100 is e.g., a router, which is capable of operating with several radio bands concurrently, and these radio bands are associated with respective ones of the radio links for the MLO. In the example of FIG. 1A, AP device 100 can concurrently operate with two radio bands B1 and B2. The radio band B1 is associated with a first radio link LK1, which is associated with e.g., a Wi-Fi CH6 channel with a 20 MHz bandwidth at the 2G band (referred to as “2G CH6 BW20”). Furthermore, the radio band B2 is associated with a second radio link LK2, which is associated with e.g., a Wi-Fi CH36 channel with an 80 MHz bandwidth at the 5G band (referred to as “5G CH36 BW80”).

More particularly, the AP device 100 includes two radio modules 11 and 12, each of which may be an RF front end circuit. The radio module 11 is configured to perform communication on the radio band B1 through the first radio link LK1, while the radio module 12 is configured to perform communication on the radio band B2 through the second radio link LK2. That is, the radio modules 11 and 12 can be concurrently operated to handle communications on dual radio bands B1 and B2, hence the AP device 100 is referred to as a multi-link device (MLD), specifically a multi-link multi-radio (MLMR) device.

On the other hand, the STA device 201 may be a mobile station device or a mobile terminal, which is referred to a non-AP multi-link device (non-AP MLD). The STA device 201 includes a single radio module 21 configured to handle communications on either one of dual radio bands B1 and B2. That is, the single radio module 21 can support dual radio bands B1 and B2 associated with the dual radio links LK1 and LK2. However, the STA device 201 (specifically, it utilizes the single radio module 21) performs communication with the AP device 100 through only one of the radio links LK1 and LK2 at a time, hence the STA device 201 is referred to as a multi-link single radio (MLSR) device.

Unlike the STA device 201 which can support the dual radio bands B1 and B2, another STA device 202 only supports a single radio band (such as the radio band B1). More particularly, the STA device 202 includes a single radio module 22 configured to handle communication on the single radio band B1, and the STA device 202 is referred to as a single-link single radio (SLSR) device.

It should be noted that, for the sake of illustration and understanding, the present disclosure introduces an example as FIG. 1A with two radio links LK1 and LK2. However, the present disclosure does not limit the number of radio links supported by the STA device 201 (for example, the STA device 201 can support three or more radio links). In the example of FIG. 1A, the first radio link LK1 is exemplified by using CH6 channel with a 20 MHz bandwidth in the 2G band, and the second radio link LK2 is exemplified by using CH36 channel with an 80 MHz bandwidth in the 5G band. However, the present disclosure is not limited to these examples.

In the MLSR operation of the STA device 201, an optimal link may be selected from the supported radio links (such as the first radio link LK1 and the second radio link LK2), and the STA device 201 performs communication with the AP device 100 through the selected optimal link. For example, when the STA device 201 communicates with the AP device 100 on a currently active link (e.g., link LK1), the STA device 201 may detect another link (e.g., link LK2) with better traffic condition than the active link. Then, the STA device 201 may select this better link as the optimal link and run-time switch to the selected optimal link from the currently active link. Thereafter, communication between the AP device 100 and the STA device 201 is performed over this newly selected optimal link, and the communication performance is improved.

In one example, the STA device 201 may determine the optimal link based on some link information associated with corresponding ones of the multiple radio links (e.g., the first radio link LK1 and the second radio link LK2). Such link information may include a received signal strength indicator (RSSI), a channel utilization, a transmission retry, and an estimated throughput, etc. For example, in a case of RSSI as link information, if the RSSI measured on the second radio link LK2 is greater than that measured on the first radio link LK1, the second radio link LK2 is determined as the optimal link.

In conventional ways, an MLSR device (compared with the STA device 201 of the present disclosure) usually performs a “probing” for all the radio links to check their link information (i.e., conditions of link loading, which reflects traffic condition of the corresponding radio link) by switching and hence determine the optimal link. However, except processing communication with the currently active link, the MLSR device further needs to take an extra effort for probing other links (this effort may be referred to as a “link probing cost”). Due to such a “link probing cost”, system performance may be deteriorated, and transmission latency may be raised.

To address the issue of link probing cost, the STA device 201 of the present disclosure is configured for determining the optimal link based on link scores associated with the supported radio links between the STA device 201 and the AP device 100. Specifically, in one example, each of the link scores may be determined according to channel load value for each radio link and channel bandwidths of the supported radio links between the STA device 201 and the AP device 100. Taking the two radio links LK1 and LK2 as an example, the channel load value for each of the radio links LK1 and LK2 are obtained by the AP device 100 but not by the STA device 201, and the AP device 100 provides the obtained channel load value to the STA device 201 for deciding the optimal link. Calculation of the channel load value is described in brief, as the follows. In the embodiment, the channel load value is carried in a field of “channel load” in a “radio measurement report frame”, wherein the radio measurement report frame is transmitted by the AP device 100 to the STA device 201. In the embodiment, the channel load value can be used to indicate a link loading (e.g., the link loading=channel load value/255), and used as the above-mentioned link information. Since the channel load value is provided by the AP device 100, while the STA device 201 is performing communication through the currently active link (e.g., the first radio link LK1), the STA device 201 can simultaneously obtain link information (e.g., the channel load value which is used to indicate the link loading) of all supported radio links (e.g., two radio links LK1 and LK2), including radio links other than the currently active link. In other words, the STA device 201 needs not to switch between multiple radio links of the supported radio links to obtain link information thereof. The STA device 201 stays in the currently active link and can still obtain channel load value of all supported radio links. Hence, when communicating via the currently active link (e.g., the radio link LK1), the STA device 201 does not need to sacrifice throughput to probe the link information of another link (e.g., the radio link LK2).

FIG. 1B is a block diagram of the STA device 201 of the communication system 1000 in FIG. 1A. As shown in FIG. 1B, except the single radio module 21, the STA device 201 further includes a processor 30 and a memory 31. The processor 30 is operatively coupled to the single radio module 21 and the memory 31. In operation, the processor 30 may cooperate with the memory 31 and be configured to control the STA device 201 to perform the MLO communication with the AP device 100.

More particularly, the processor 30 is configured to control the single radio module 21 to handle MLO communications on either of the dual radio bands B1 and B2, as described in former paragraphs. For example, the processor 30 is configured to select the optimal link from the radio links LK1 and LK2 based on their respective link scores SC, and the processor 30 is configured to control the single radio module 21 to communicate with the AP device 100 through optimal link selected by the processor 30.

Some or all the calculations for the link selection mechanism may be performed by the processor. For example, the link score SC in equation (2) may be calculated by the processor 30. Furthermore, the processor 30 may evaluate the link scores SC of all the supported radio links (e.g., the radio links LK1 and LK2), and the processor 30 evaluates the highest one of the link scores SC and then determines the optimal link with the highest link score SC. Thereafter, the processor 30 may send a control signal to command the single radio module 21 to switch to the optimal link.

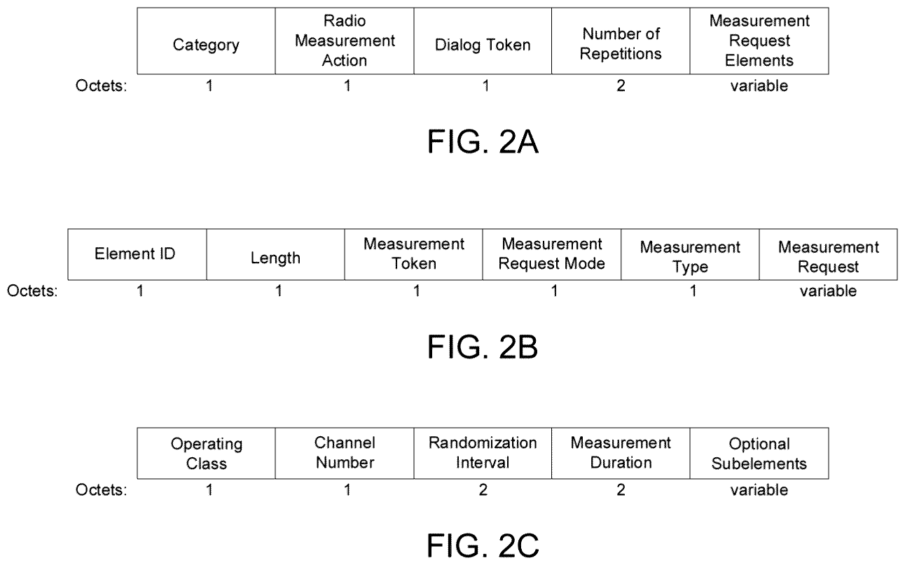

Now, details of deriving the channel load value are described. The STA device 201 may send a radio measurement request frame to the AP device 100 to request measurements on at least one of the channels associated with the radio links. In one example, in the STA device 201, the processor 30 is configured to control the single radio module 21 to transmit the above-mentioned radio measurement request frame. More particularly, please refer to FIG. 2A, which is a schematic diagram illustrating a format of action fields in the radio measurement request frame. In the action fields, a field of “measurement request element” is provided. The measurement request element comprises measurement request field for a channel load request, i.e., a request that the AP device 100 should undertake this specified measurement action. Then, referring to FIG. 2B, which is a schematic diagram illustrating a format of the measurement request element of FIG. 2A. The measurement request element includes a field of “measurement request” which corresponds to a channel load request.

Then, referring to FIG. 2C, which is a schematic diagram illustrating a format of the measurement request field for the channel load request. The measurement request field comprises at least a field of “operating class”, a field of “channel number” and a field of “measurement duration”. The operating class field may be used to indicate the corresponding band (e.g., the bands of 2 GHz or 5 GHZ, etc.). Furthermore, the channel number field may be used to indicate the corresponding channel (e.g., the channels of CH6 or CH35, etc.) by a channel index, wherein channel bandwidth (e.g., the bandwidths of 20 MHz, 40 MHz or 80 MHz, etc.) for the corresponding channel can also be determined by the operating class field and the channel number field. Moreover, the field of measurement duration MD may be used to indicate a time length for the duration of the requested measurement. In one example, the measurement duration MD is set to a preferred or mandatory duration in units of “TU” (e.g., 1 TU (time unit) is equal to 1024 microseconds).

With the radio measurement request frame, the STA device 201 may request the AP device 100 to periodically transmit the radio measurement report frame in response, via the currently active link (e.g., radio link LK1). Alternatively, the AP device 100 may periodically transmit the radio measurement report frame for each respective one of the radio links on the currently active link. Furthermore, in the STA device 201, the processor 30 is configured to control the single radio module 21 to receive the radio measurement report frame sent by the AP device 100 via the currently active link. Thereafter, the single radio module 21 is controlled by the processor 30 to retrieve the channel load field of the received measurement report field, from the radio measurement report frame. Then, the single radio module 21 is controlled by the processor 30 to figure out the channel load value CL based on the retrieved channel load field.

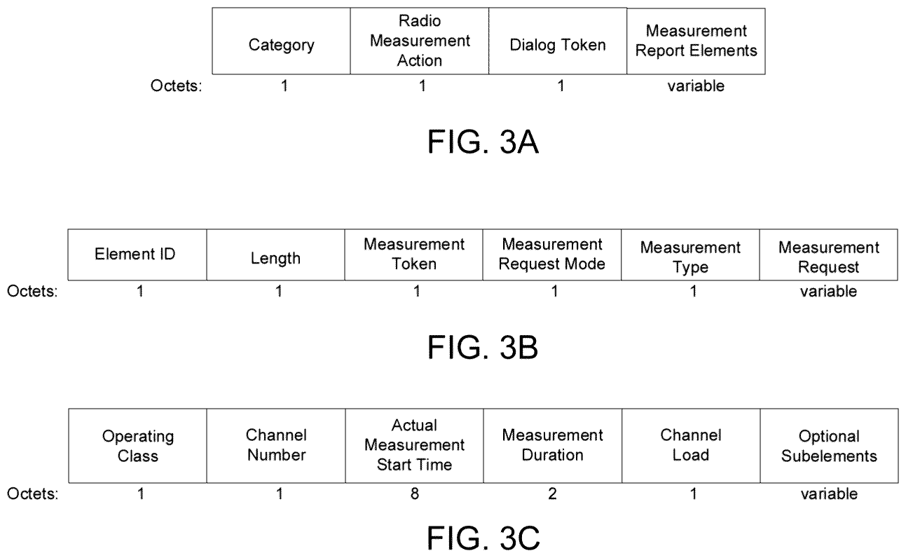

The radio measurement report frame may indicate link information (including the channel load value which is used to indicate the link loading) of the corresponding radio link. Please refer to FIG. 3A, which is a schematic diagram illustrating a format of action fields in the radio measurement report frame. In the action fields, a field of “measurement report element” is provided. The measurement report element may provide some information reported for this specified measurement action requested by the STA device 201.

Then, referring to FIG. 3B, which is a schematic diagram illustrating a format of the measurement report element of FIG. 3A. The measurement report element includes a field of “measurement report” for a channel load report, e.g., for the requested measurement action by the STA device 201.

Then, referring to FIG. 3C, which is a schematic diagram illustrating a format of the measurement report field of FIG. 3B. The measurement report field may comprise some fields same as those in the measurement request field of FIG. 2C (e.g., the fields of operating class, channel number and measurement duration. Furthermore, the measurement report field further comprises a field of “channel load”. The channel load field may comprise a value (referred to as a channel load value CL) which is used to evaluate a channel utilization (which can reflect link loading) of the corresponding one of the radio links and measured by the AP device 100. In the embodiment, the channel load value CL is used to provide a quantification for the link loading.

The channel load value CL is measured by the AP device 100, wherein the channel load value CL is proportional to a ratio value between a channel busy time and the measurement duration. In some embodiment, the channel load value CL is defined as the percentage of time, linearly scaled such that 255 represents 100%, and it can be represented as equation (1):

$$CL = \frac{C B T}{( MD \times 1024 )} \times 255 \qquad ( 1 )$$

In equation (1), the channel load value CL represents the level of busyness of the channel during the measurement duration MD (channel load value CL may also reflect the utilization of this interested channel). The measurement duration MD represents a time length with which the channel load value CL is measured, which is set to the preferred or mandatory duration of the requested measurement, in units of TUs. Furthermore, the channel busy time CBT refers to a time length for a full utilization of the channel of the respective radio link (e.g., LK1 or LK2), within the measurement duration MD. For example, channel busy time CBT may be represented with the number of microseconds.

In the embodiment expressed by equation (1), the channel load value CL is an integer between 0 and 255 which may indicate the link loading (symbolized by “LL”), wherein the link loading LL is defined as the channel load value CL divided by 255. Therefore, if the channel load value CL is 255, it means the link loading LL is 1 (i.e., 100%), reflecting a full utilization (i.e., fully business) of the corresponding channel. The value of the link loading ranges from 0 to 1.

In addition, the channel load value CL, in conjunction with the channel bandwidths of the radio links, may be used to calculate a link score SC for each respective radio link. In one example, the link score SC is a product of a bandwidth ratio BR and a value of one minus the link loading LL, as shown in equation (2):

$$SC = BR \times ( 1 - LL ) , wherein LL = CL / 255 \qquad ( 2 )$$

The bandwidth ratio BR is defined by a ratio value between the bandwidths of the radio links. In detail, the bandwidth ratio BR is calculated taking the highest or lowest bandwidth among the radio links as a base. In aforementioned examples, the second radio link LK2 is associated with the channel “5G CH36 BW80”, and the first radio link LK1 is associated with the channel “2G CH6 BW20”, wherein the highest bandwidth of the radio links is 80 MHz and the lowest bandwidth of the radio links is 20 MHz. When the highest bandwidth 80 MHz is taken as the base, the radio link LK2 has a bandwidth ratio BR calculated as “1”, and the radio link LK1 has a bandwidth ratio BR calculated as “0.25”. Similarly, in another embodiment, when the lowest bandwidth 20 MHz is taken as the base, the radio link LK1 has a bandwidth ratio BR of “1” while the radio link LK2 has a bandwidth ratio BR of “4”. In short, the link score SC takes into account the channel bandwidth of each radio link.

With the definition in equation (2), link score SC of the radio link LK1 (associated with the channel “2G CH6 BW20”) and the radio link LK2 (associated with the channel “5G CH36 BW80”) are evaluated. For example, the radio link LK1 has a link loading LL of 0.5, and the link score SC of the radio link LK1 is calculated by 0.25×(1−0.5), which is equal to 0.125. Likewise, the radio link LK2 has a link loading LL of 0.75 and hence a link score SC of the radio link LK2 equals to 0.25 (calculated by 1×(1−0.75)). The radio link LK2 has a higher link score SC, indicating that the radio link LK2 has a better traffic condition (e.g., light traffic load), hence the STA device 201 may select the radio link LK2 as the optimal link for performing communication with the AP device 100. Therefore, if the currently active link is the first radio link LK1, the STA device 201 will “switch out” from the currently active link LK1 and switch to the optimal link LK2, so as to achieve better throughput and performance. In other aspect, if the currently active link is the second radio link LK2, the STA device 201 will continue to operate on the currently active link LK2.

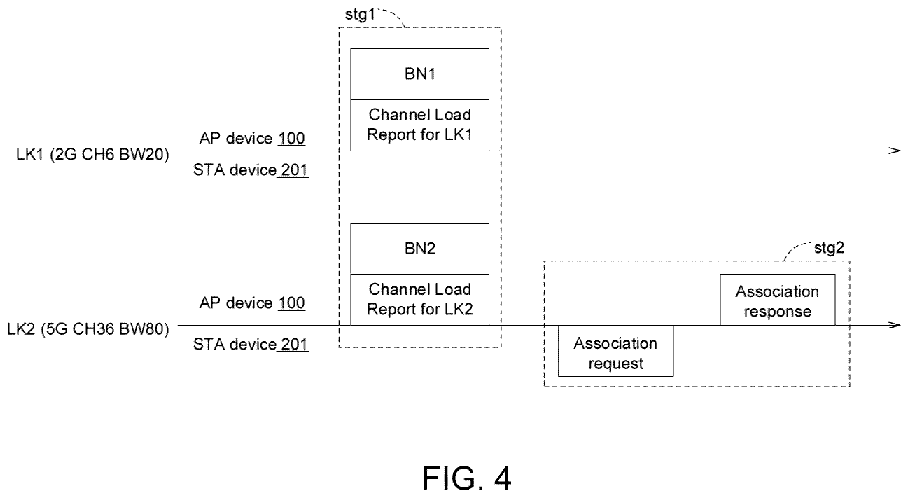

FIG. 4 is a schematic diagram illustrating the STA device 201 determines an optimal link for subsequent communication with the AP device 100 during the process of establishing a connection according to an embodiment of the present disclosure. As shown in FIG. 4, in a first stage stg1, the AP device 100 may broadcast beacon frames BN1 and BN2 over the radio links LK1 and LK2, and the STA device 201 may scan the radio links LK1 and LK2 to receive the beacon frames BN1 and BN2. In the embodiment, the beacon frames BN1 and BN2 may comprise a specific information element (IE) for channel load report which is similar with the above-mentioned measurement report element respectively. Thereafter, based on the IE for channel load report in the beacon frames BN1 and BN2, the STA device 201 may retrieve channel load value CL and determine bandwidth information (e.g., bandwidth ratio BR) for each radio link respectively. Based on the channel load value CL and the bandwidth ratio BR for each radio link, the STA device 201 may calculate the link score SC for each of the radio links LK1 and LK2 (e.g., based on the calculations shown in equations (2)), and then select an optimal link out of the radio links LK1 and LK2 based on the link score SC.

For example, the radio link LK1 is associated with the Wi-Fi CH6 channel with a 20 MHz bandwidth at the 2G band (i.e., “2G CH6 BW20”). The channel load report for the radio link LK1 obtained from the beacon frame BN1 may reflect the operating class indicating the band of “2G”, and reflect the channel number indicating the channel of “CH6”. Furthermore, the channel load report from the beacon frame BN1 may also reflect the channel bandwidth of “BW20”.

Likewise, the radio link LK2 is associated with the Wi-Fi CH36 channel with an 80 MHz bandwidth at the 5G band (i.e., “5G CH36 BW80”). The channel load report for the radio link LK2 obtained from the beacon frame BN2 may reflect the operating class indicating the band of “5G”, and reflect the channel number indicating the channel of “CH36”. Furthermore, the channel load report from the beacon frame BN2 may also reflect the channel bandwidth of “BW80”.

Based on the channel bandwidths of “BW20” and “BW80”, the STA device 201 may calculate the bandwidth ratio BR as 4, when taking the lowest channel bandwidth 20 MHz as the base. Then, based on equation (2) the STA device 201 may calculate the link score SC for each of the radio links LK1 and LK2, and hence decide the optimal link with the highest link score SC.

In the embodiment, the STA device 201 may perform communication with the AP device 100 through the optimal link determined based on the information carried in the beacon frames BN1 and BN2. For example, in a second stage stg2, the STA device 201 may send a frame of “association request” to the AP device 100 through the determined optimal link (e.g., LK2). Upon receiving the frame of “association request”, the AP device 100 may send a frame of “association response” to the STA device 201 as a reply. Hence, the STA device 201 may establish a connection with the AP device 100 through the optimal link, specifically, the optimal link LK2 is an active link, and other link LK1 is an inactive link. Then, the STA device 201 utilizes the optimal link as the currently active link to communicate with the AP device 100.

As mentioned above, the STA device 201 is controlled by the processor 30 to perform communications with the AP device 100. In the example of FIG. 4, the beacon frames BN1 and BN2 are scanned by the processor 30, and the processor 30 is configured to retrieve the measurement report field from the specific information element of the beacon frames BN1 and BN2. The processor 30 utilizes the measurement report field to obtain the channel load report, so as to figure out the channel information and the channel load value CL. Then, the processor 30 is configured to control the single radio module 21 to establish the connection with the AP device 100, utilizing the channel load value CL to figure out the link scores SC of the radio links LK1 and LK2, and thereby figuring out the optimal link.

Alternatively, the STA device 201 may also establish a connection with the AP device 100 through conventional methods. After the connection is established or during communication, the AP device 100 may periodically send a beacon frame via an active link. Assuming a plurality of links connected between the AP device 100 and the STA device 201 include the radio link LK1 (as the active link) and the radio link LK2 (as an inactive link), hence, the beacon frame is communicated via the active link LK1. In the embodiment, the beacon frame comprises a plurality of specific information elements (IEs) each of which comprises a measurement report field corresponding to a respective link/channel for channel load report, and as described above, a channel load value is accordingly carried in a channel load field of the measurement report field. Thus, after receiving such a beacon frame, the STA device 201 can determine an optimal link for communication due to the beacon frame comprises a first specific IE for the LK1 or its associated channel and a second specific IE for the LK2 or its associated channel.

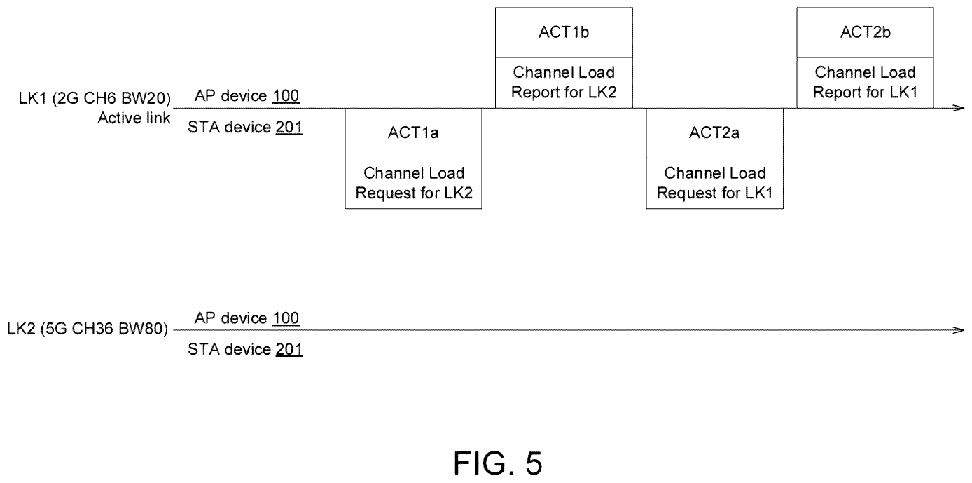

FIG. 5 is a schematic diagram illustrating the STA device 201 requests channel load reports for the radio links LK1 and LK2 from the AP device 100, according to another embodiment of the present disclosure. In this embodiment, the STA device 201 has established a connection with the AP device 100 through the radio link LK1 as the currently active link. The STA device 201 performs communication with the AP device 100 in this active link LK1. And the STA device 201 stays in this active link LK1 to obtain link information associated with all the supported radio links (e.g. both of the radio links LK1 and LK2).

In operation, the STA device 201 may transmit an action frame ACT1a to the AP device 100, where the action frame ACT1a serves as a channel load request to request the link formation for either one of the radio links LK1 and LK2. In the example of FIG. 5, the action frame ACT1a is used to request the link formation for the radio link LK2, and the action frame ACT1a may be a radio measurement request frame as illustrated in FIGS. 2A to 2C.

Upon receiving the action frame ACT1a, the AP device 100 may send a response frame ACT1b to response the STA device 201. The response frame ACT1b may be a radio measurement report frame as illustrated in FIGS. 3A to 3C, which serves as a channel load report to response the channel load request by the action frame ACT1a. For example, the response frame ACT1b may comprise a measurement report field including the channel load field, the operating class field and channel number field associated with the radio link LK2. The STA device 201 may obtain the channel load value CL from the channel load field, and band of “2G”, the channel of “CH6” and channel bandwidth of “BW20” from the operating class field and the channel number field.

Similarly, the STA device 201 may stay in the active link (radio link LK1) to obtain link information of radio link LK1. The STA device 201 transmits an action frame ACT2a to the AP device 100 which serves as a channel load request to request the link formation for radio link LK1. Then, the AP device 100 may send a response frame ACT2b to response the STA device 201, which serves as a channel load report to response the channel load request by the action frame ACT2a.

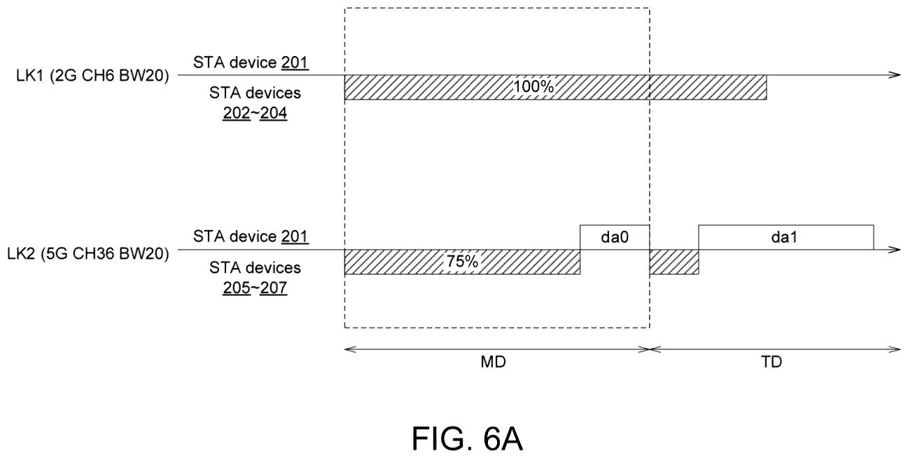

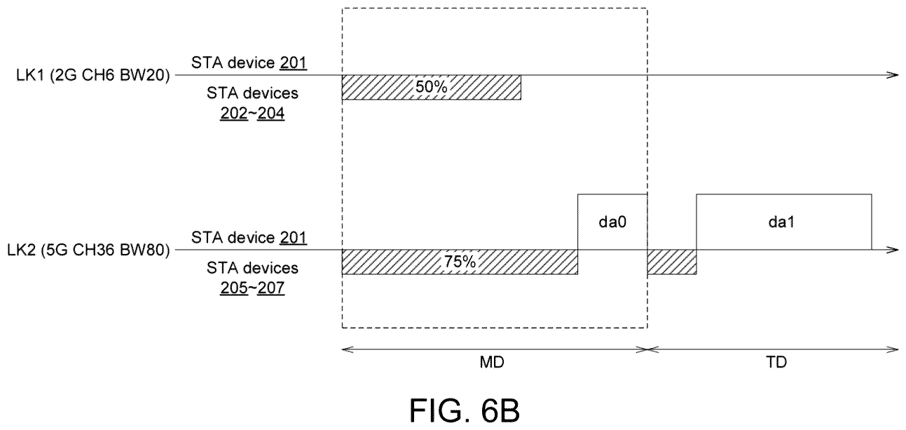

FIG. 6A is a schematic diagram illustrating the STA device 201 decides an optimal link of the radio links LK1 and LK2, according to an embodiment of the present disclosure. In the example as shown by FIG. 6A, the radio link LK1 is associated with a channel “2G CH6” having a bandwidth of 20 MHz, and the radio link LK2 is associated with a channel “5G CH36” having a bandwidth of 20 MHz. The highest bandwidth of the radio links LK1 and LK2 is 20 MHz, hence both radio links LK1 and LK2 have a bandwidth ratio BR of “1”. In this embodiment, seven STA devices 201, 202, 203, 204, 205, 206 and 207 perform communication with the AP device 100 through the radio links LK1 and LK2. The STA device 201 of interest is a MLSR device concurrently connects to two radio links LK1 and LK2 of the AP device 100. On the other hand, the other STA devices 202~207 (the five STA devices 203~207 are not shown in FIG. 1A) may be SLSR devices supporting single radio band. Especially, the three STA devices 202~204 connect to the AP device 100 through the radio link LK1, and the other three STA devices 205~207 connect to the AP device 100 through the radio link LK2.

In the measurement duration MD for the radio link LK1, the capacity of the radio link LK1 is almost occupied by the STA devices 202~204. The channel busy time BT almost occupies the whole measurement duration MD, hence, based on equation (1) the channel load value CL is calculated as “255” for indicating a link loading “100%” as shown in FIG. 6A). Furthermore, the link score SC of the radio link LK1 is calculated as “0” based on equation (2).

On the other hand, for another radio link LK2, during the measurement duration MD a capacity of 75% for the radio link LK2 is occupied by the STA devices 205~207, and a channel load value CL is calculated as “191” for indicating a load linking “75%” as shown in FIG. 6A. The AP device 100 sends a channel load report to the STA device 201, informing the channel load value CL of “191” for the radio link LK2. Then, based on equation (2), the link score SC of the radio link LK2 is calculated as “0.25”. Since the link score SC (i.e., “0.25”) of the radio link LK2 is higher than the link score SC (i.e., “0”) of the radio link LK1, the STA device 201 may evaluate the radio link LK2 as the optimal link. Therefore, in a traffic duration TD subsequent to the measurement duration MD, the STA device 201 continues to communicate with the AP device 100 over radio link LK2 in which data dal is conveyed.

FIG. 6B is a schematic diagram illustrating the STA device 201 decides an optimal link of the radio links LK1 and LK2, according to another embodiment of the present disclosure. The embodiment of FIG. 6B is similar to that of FIG. 6A except that, the radio link LK2 is a “5G CH36 BW80” link having a bandwidth of 80 MHz. The highest bandwidth of the radio links LK1 and LK2 is 80 MHz, hence radio link LK1 has a bandwidth ratio BR of “0.25”, and radio link LK2 has a bandwidth ratio BR of “1”. In the measurement duration MD for evaluating link loading of the radio link LK1, it's measured that the STA devices 202~204 utilize the radio link LK1 by a capacity of 50%, and the AP device 100 provides a channel load report showing that radio link LK1 has a channel load CL of 127 for indicating a link loading “50%”. Furthermore, the link score SC of the radio link LK1 is calculated as “0.125” based on equation (2).

On the other hand, in the measurement duration MD, it's measured that the STA devices 205~207 utilize the radio link LK2 by a capacity of 75%, which results in the channel load value CL of “191” for indicating a load linking 75%, and the radio link LK2 is calculated to have the link score SC of “0.25” based on equation (2).

The measurement result in the measurement duration MD shows that the radio link LK2 has a higher link score SC (i.e., “0.25”) than the link score SC (i.e., “0.125”) of the radio link LK1, and therefore, the STA device 201 still selects the radio link LK2 as the optimal link and continues to convey data dal in a traffic duration TD.

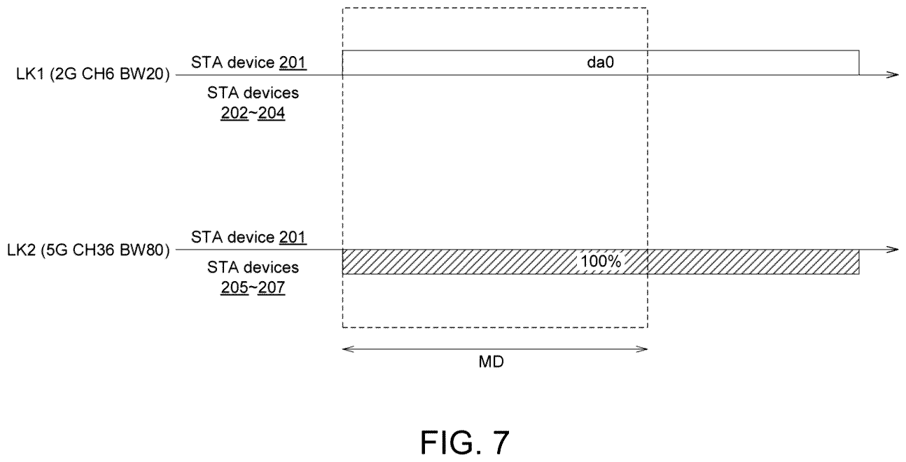

FIG. 7 is a schematic diagram illustrating the STA device 201 decides an optimal link of the radio links LK1 and LK2, according to still another embodiment of the present disclosure. In this embodiment, the radio link LK1 is a “2G CH6 BW20” link having a bandwidth of 20 MHz and a bandwidth ratio BR of “0.25”. The STA device 201 utilizes the radio link LK1 to convey data da0 and occupies a capacity of 100% for the radio link LK1. Hence, the STA devices 202~204 occupy a capacity of 0% for the radio link LK1, and the channel load report showing that radio link LK1 has a channel load value CL of 0 for indicating a load linking “0%” occupied by the other STA devices (e.g., STA devices 202~204). Furthermore, the link score SC of the radio link LK1 is calculated as “0.25” based on equation (2).

On the other hand, the radio link LK2 is a “5G CH36 BW80” link having a bandwidth of 80 MHz and a bandwidth ratio BR of “1”. The STA devices 205~207 occupy a capacity of 100% for the radio link LK2, which results in a channel load value CL of 255 for indicating a link loading “100%” occupied by the other STA devices (e.g., STA devices 205~207). Furthermore, the link score SC of the radio link LK2 is calculated as “0” based on equation (2). The radio link LK2 has a lower link score SC (i.e., “0”) than the link score SC (i.e., “0.25”) of the radio link LK1, hence the STA device 201 select the radio link LK1 as the optimal link for communicating with the AP device 100.

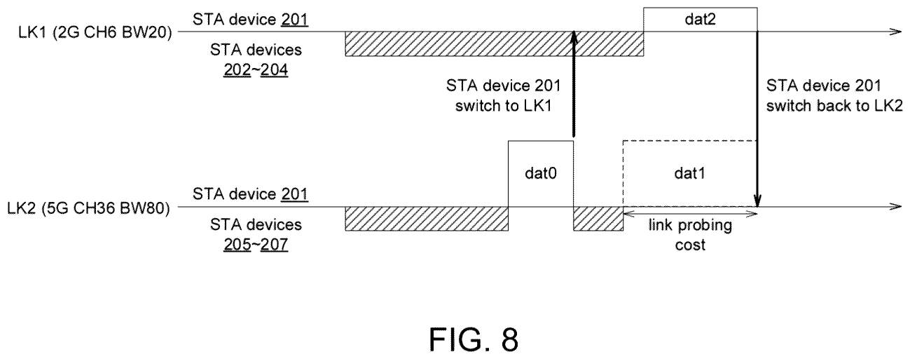

FIG. 8 is a schematic diagram illustrating the STA device 201 decides the optimal link in a comparative example. In this comparative example, the radio link LK1 is a “2G CH6 BW20” link with 20 MHz bandwidth and bandwidth ratio BR of “0.25”, while the radio link LK2 is a “5G CH36 BW80” link with 80 MHz bandwidth and bandwidth ratio BR of “1”.

In an early stage of the connection over the radio link LK2, the STA devices 205~207 occupy the radio link LK2 for communication. Then, after this early stage, the STA device 201 occupies the radio link LK2 for conveying data dat0. While the STA device 201 conveys data dat0 over the radio link LK2, in the meantime, the STA devices 202~204 occupy the other radio link LK1 for communication.

In this comparative example, when the STA device 201 determines whether if selecting radio link LK1 as the optimal link, the STA device 201 needs switching to radio link LK1 for probing link loading. After the STA device 201 switches to radio link LK1, the STA device 201 needs waiting traffic of other STA devices 202~204. The STA device 201 can utilize the radio link LK1 to convey data dat2 until the traffic of other STA devices 202~204 is done.

Regarding a case in which the STA device 201 does not switch to radio link LK1 to probe link loading, the STA device 201 can still utilize the original used radio link LK2. In this case, after the traffic of other STA devices 205~207 is done, the STA device 201 can convey data dat1 over radio link LK2. In contrast, if STA device 201 needs switching to radio link LK1 to probe link loading, the benefit for conveying data dat1 over radio link LK2 will be sacrificed. This sacrificed benefit for conveying data dat1 is referred to as a “link probing cost” spent by switching to radio link LK1 to probe channel loading.

Referring back to the embodiments of FIGS. 6A/6B/7 of the present disclosure, the STA device 201 needs not switching to the other radio link LK1 for probing link loading. Instead, link loading information of radio link LK1 (i.e., which is indicated by the channel load value CL) is provided by the AP device 100, and the STA device 201 may stay in the original radio link LK2 to receive the link loading information of radio link LK1. In this manner, the STA device 201 may stay in the original radio link LK2 to convey data, hence the above mentioned “link probing cost” for probing radio link LK1 will not be induced. Thus, the performance (such as throughput) can be improved.

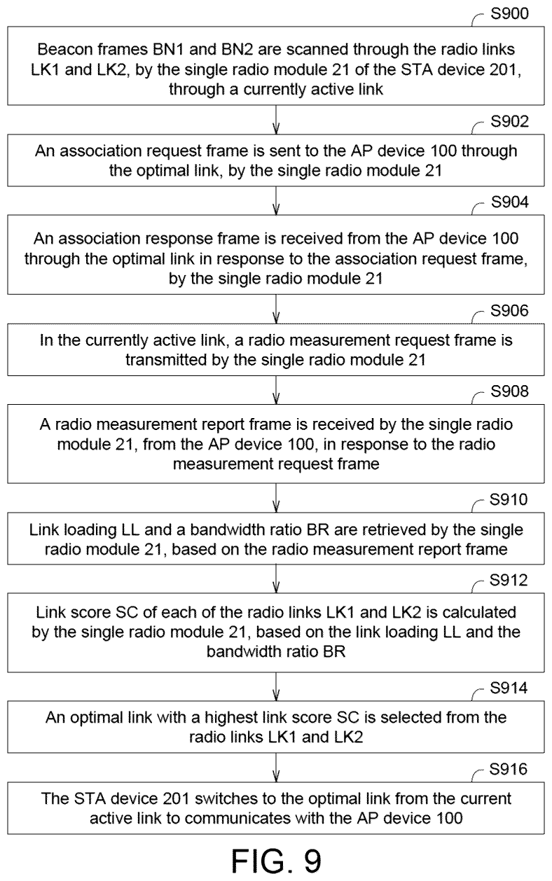

FIG. 9 is a flow diagram illustrating a communication method according to an embodiment of the present disclosure. In step S900, when establishing of a connection between the STA device 201 with the AP device 100, beacon frames BN1 and BN2 are scanned through the radio links LK1 and LK2, by the single radio module 21 of the STA device 201. As described above, in some embodiments, the beacon frame BN1 and BN2 may carry a corresponding information element (IE) for channel load report respectively, so that an optimal link can be determined during the connection establishment phase.

Next, in step S902, an association request frame is sent to the AP device 100 through the optimal link, by the single radio module 21 of the STA device 201. Next, in step S904, an association response frame is received from the AP device 100 through the optimal link in response to the association request frame, by the single radio module 21 of the STA device 201. Hence, the STA device 201 communications with the AP device 100 through the optimal link. Next, in step S906, in the currently active link (e.g., radio link LK1), a radio measurement request frame is transmitted by the single radio module 21 of the STA device 201.

Next, in step S908, a radio measurement report frame is received by the single radio module 21 of the STA device 201, from the AP device 100, in response to the radio measurement request frame. Next, in step S910, link loading LL and a bandwidth ratio BR are retrieved by the processor 30 of the STA device 201, based on the radio measurement report frame.

Next, in step S912, link score SC of each of the radio links LK1 and LK2 is calculated by the processor 30 of the STA device 201, based on the link loading LL and the bandwidth ratio BR. Next, in step S914, a new optimal link may be determined from the radio links LK1 and LK2 based on the link score SC of each of the radio links LK1 and LK2, wherein the optimal link has the link score SC with a highest value. Next, in step S916, the STA device 201 switches to the optimal link from the current active link, and utilizes the single radio module 21 to perform communications with the AP device 100 through the optimal link.

The flowchart and block diagrams in the diagrams illustrate the architecture, functionality, and operation of possible implementations of devices and methods according to various embodiments of the present embodiments. It is noted that various blocks of the block diagrams and/or flowchart illustrations, and combinations of blocks in the block diagrams and/or flowchart illustrations may be divided into additional blocks, combined into fewer blocks, or eliminated, depending on the desired implementation. Furthermore, one or more of the steps of the method may be executed repeatedly.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A multi-link single radio (MLSR) device, comprising:
a processor, configured for selecting an optimal link from a plurality of radio links between the MLSR device and an AP device based on a plurality of link scores of the radio links; and
a single radio module, configured for communicating with the AP device through the selected optimal link,
wherein each of the radio links is associated with a respective channel and a corresponding link score, and the corresponding link score is determined based on a channel bandwidth corresponding to the respective channel and a channel load value received from the AP device.

2. The MLSR device of claim 1, wherein when the MLSR device communicates with the AP device through a currently active link among the radio links, and the processor is further configured for obtaining the plurality of link scores of the radio links without the MLSR device switching out from the currently active link; and wherein the selected optimal link is the one with the highest link score among all the radio links.

3. The MLSR device of claim 1, wherein the single radio module is further configured for receiving a beacon frame on a currently active link from the AP device, and wherein the beacon frame comprises a plurality of information element each of which comprises a measurement report field corresponding to the respective channel for channel load report, and the channel load value is carried in a channel load field of the measurement report field.

4. The MLSR device of claim 1, wherein the link score of a corresponding one of the radio links is related to a link loading and a bandwidth ratio, and the link loading has a value ranging from 0 to 1 and is proportional to the channel load value; and wherein the bandwidth ratio indicates a ratio value of the channel bandwidth of the corresponding one of the radio links with respect to a highest bandwidth or a lowest bandwidth among the radio links.

5. The MLSR device of claim 1, wherein the single radio module is further configured for receiving an action frame which is a radio measurement report frame for a corresponding one of the radio links on a currently active link, which comprises a measurement report field for channel load report from the AP device, and wherein the channel load value is carried in a channel load field of the measurement report field.

6. The MLSR device of claim 5, wherein the measurement report field comprises a measurement duration field which indicates a measurement duration representing a time length for measuring the corresponding one of the radio links, and the channel load value is proportional to a ratio value between a channel busy time and the measurement duration; and wherein the channel busy time indicates a time length for a full utilization of a channel of the corresponding one of the radio links.

7. The MLSR device of claim 6, wherein the measurement report field further comprises an operating class field and a channel number field which are used to indicate a corresponding band and a corresponding channel with a specific bandwidth.

8. The MLSR device of claim 5, wherein the single radio module is further configured for transmitting a radio measurement request frame for the corresponding one of the radio links on the currently active link, which comprises a measurement request field for a channel load request, and the radio measurement report frame is received in response to the radio measurement request frame; or the radio measurement report frame is periodically received.

9. The MLSR device of claim 1, wherein the processor is further configured for scanning for a plurality of beacon frames through all the radio links via the single radio module during establishing a connection between the MLSR device and the AP device, and each of the beacon frames comprises an information element which comprises a measurement report field for channel load report comprising information about a corresponding channel and a corresponding channel load value.

10. The MLSR device of claim 9, wherein during establishing the connection between the MLSR device and the AP device, the single radio module is further configured for transmitting an association request frame to the AP device through the optimal link, and receiving an association response frame from the AP device through the optimal link in response to the association request frame.

11. A communication method, performed by a multi-link single radio (MLSR) device, comprising:
selecting an optimal link from a plurality of radio links between the MLSR device and an AP device based on a plurality of link scores of the radio links; and
communicating with the AP device through the selected optimal link, by a single radio module of the MLSR device,
wherein each of the radio links is associated with a respective channel and a corresponding link score, and the corresponding link score is determined based on a channel bandwidth corresponding to the respective channel and a channel load value received from the AP device.

12. The communication method of claim 11, wherein when communicating with the AP device through a currently active link among the radio links, the communication method further comprising:
obtaining the plurality of link scores of the radio links without the MLSR device switching out from the currently active link;
wherein the selected optimal link is the one with the highest link score among all the radio links.

13. The communication method of claim 11, wherein the communication method further comprising:
receiving a beacon frame on a currently active link from the AP device, and wherein the beacon frame comprises a plurality of information element each of which comprises a measurement report field corresponding to the respective channel for channel load report, and the channel load value is carried in a channel load field of the measurement report field.

14. The communication method of claim 11, wherein the communication method further comprising:
calculating the link score of a corresponding one of the radio links with a link loading and a bandwidth ratio,
wherein the link loading has a value ranging from 0 to 1 and is proportional to the channel load value; and wherein the bandwidth ratio indicates a ratio value of the channel bandwidth of the corresponding one of the radio links with respect to a highest bandwidth or a lowest bandwidth among the radio links.

15. The communication method of claim 11, wherein the communication method further comprising:
utilizing the single radio module of the MLSR device to receive an action frame which is a radio measurement report frame for a corresponding one of the radio links on a currently active link from the AP device,
wherein the radio measurement report frame comprises a measurement report field for channel load report, and wherein the channel load value is carried in a channel load field of the measurement report field.

16. The communication method of claim 15, wherein the measurement report field comprises a measurement duration field which indicates a measurement duration representing a time length for measuring the corresponding one of the radio links, and the channel load value is proportional to a ratio value between a channel busy time and the measurement duration; and wherein the channel busy time indicates a time length for a full utilization of a channel of the corresponding one of the radio links.

17. The communication method of claim 16, wherein the measurement report field further comprises an operating class field and a channel number field which are used to indicate a corresponding band and a corresponding channel with a specific bandwidth.

18. The communication method of claim 15, wherein the radio measurement report frame is periodically received; or the communication method further comprising:
utilizing the single radio module to transmit a radio measurement request frame for the corresponding one of the radio links on the currently active link,
wherein the radio measurement request frame comprises a measurement request field for a channel load request, and the radio measurement report frame is received in response to the radio measurement request frame.

19. The communication method of claim 11, wherein during establishing a connection between the MLSR device and the AP device, the communication method further comprising:
scanning for a plurality of beacon frames through all the radio links, by the single radio module of the MLSR device,
wherein each of the beacon frames comprises an information element which comprises a measurement report field for channel load report comprising information about a corresponding channel and a corresponding channel load value.

20. The communication method of claim 19, wherein the communication method further comprising:
after scanning the plurality of beacon frames, transmitting an association request frame to the AP device through the optimal link, by the single radio module of the MLSR device; and
receiving an association response frame from the AP device through the optimal link in response to the association request frame.
